(19) United States
(12) Patent Application Publication
(10) Pub. No.: US 2008/0093750 A1
(43) Pub. Date: Apr. 24, 2008

(54) Dual inlet water tank for a humidifier

(76) Inventors: Zhijing Wang, Clifton Park, NY (US); Linda Hotz, New City, NY (US); Richard Thrush, Jersey City, NJ (US); Ting Wen Nieh, Clifton Park, NY (US); Steven Richard Remy, New York, NY (US); James Evangelist Anthony, New York, NY (US); Paul Dowd, Bronxville, NY (US)

Correspondence Address: DARBY & DARBY P.C., P.O. BOX 770, Church Street Station, New York, NY, 10008-0770, US

(21) Appl. No.: 11/583,229

(22) Filed: Oct. 18, 2006

(51) Int. Cl. B01F 3/04

(52) U.S. Cl. 261/66; 261/72.1

(57) ABSTRACT

A water tank for a humidifier having a water passage in each of its top end and bottom end. The tank includes an actuator which is operable to open and close both of the passages. Operating the actuator opens the top passage while closing the bottom passage and opens the bottom passage while closing the top passage. Accordingly, the water tank may be filled through the top passage while placed in a humidifier tray.

### FIELD OF THE INVENTION

The invention generally relates to portable domestic humidifiers and more specifically relates to portable domestic humidifiers with reservoir tanks.

### BACKGROUND

Portable humidifiers are an economical appliance for improving indoor environmental conditions. Small humidifiers are convenient because they can easily be moved or stored. This is especially convenient in locations with changing climates. The humidifier can be used when the air is very dry, and stored away when the air is humid.

Most portable humidifiers are designed to operate most efficiently with a specific amount of water. For example, wick-type humidifiers have a certain water level that is optimal for operation of the humidifier. Wick-type humidifiers typically include a wick and a fan. The wick sits in a pool of water held in a tray and the water is absorbed the wick. Thus, if the water level is too low, the air blows through less of the wick resulting in less water output. On the other hand, if the water level is too high, the air is not able to blow over enough of the wick to capture a significant amount of water.

As the humidifier operates, the water level tends to naturally decrease. In order to keep the water at the optimum level, a water tank is utilized. The water tank continuously feeds water to the humidifier to maintain the optimal water level. The water tank also enables the humidifier to operate over extended periods of time by replenishing the water in the tray of the humidifier.

A typical humidifier water tank is a sealed container with an outlet valve in the bottom. The outlet valve is usually spring-loaded and opens upon placement of the tank onto the tray. When the tank is first placed over the empty water tray of the humidifier the water flows down into the tray. As the water leaves the tank, the pressure at the top of the sealed tank decreases. The pressure continues to decrease as water leaves the tank until the pressure is low enough to hold the water in the tank. Air is then sucked into the tank restoring the pressure and allowing the water to flow out again. This process continues with water flowing out of the tank in cycles while the tray is filled. Once the water level in the tray reaches its maximum height, it covers the outlet of the water tank. Consequently, air is prevented from being sucked into the tank because the air path to the tank outlet is blocked by the water in the tray. This keeps the pressure in the water tank low and stops the water from flowing out. The water flow does not resume until the water level in the tank has fallen to a point that allows air to be sucked into the tank and restore the pressure therein.

Humidifier water tanks include openings so that they can be refilled. The opening has a cap such that it can be opened and closed. Typically, the opening and its cap are provided in the bottom of the tank. In some cases, the outlet valve is integrated in the cap of the opening. Having the tank opening in the bottom of the tank requires the user to remove the water tank from the humidifier and flip it over before pouring more water into the tank. Many users find this to be a nuisance, especially when refilling repeatedly in a short period of time or when the tank is large. However, such tanks are intended to be operated this way. If the opening were provided in the top of the tank, the user would still be required to remove the tank before refilling it. Removing the tank would close the spring-loaded outlet valve, and the cap could be removed and the tank refilled. However, at some point the user would undoubtedly attempt to fill the tank while it was placed on the tray. As soon as the user opened the cap enough to allow air to pass into the tank, the tank would effectively become a hose, with an opening in the top, and an opening in the bottom at the spring-loaded outlet valve. The water would continuously flow out of the tank, overflow the tray and make a mess. There would be no low pressure suction in the tank to hold the water therein.

Nonetheless many users find the water tank with the opening in the bottom a nuisance. There is thus a need for a tank which can be filled from the top while remaining on the tray of a humidifier.

### SUMMARY OF THE INVENTION

The present invention is directed to a water tank for a humidifier that has an opening in its top end. In operation the tank sits on a tray of the humidifier. Water flows from the tank into the tray. The water is dispersed from the tray by a humidifier mechanism. The top opening of the water tank can be opened while the tank is in place on the tray of the humidifier. The tank may also include an opening in the bottom of the tank, such that both ends of the tank have an opening, allowing refilling from either end.

The humidifier includes an actuator for opening and closing passages at both the top end and the bottom end of the water tank. A single actuator can be used for operating both passages. If a single actuator is used, it opens one passage while closing the other and vice versa. The single actuator ensures that the water tank is never open at both the top and bottom, preventing water from continuously pouring out through the tank when the tank is being filled in place.

The actuator may be activated by opening and closing a cap in the top end of the water tank. Such an arrangement guarantees that the user will activate the actuator when attempting to add water through the top opening of the tank.

### BRIEF DESCRIPTION OF THE DRAWINGS

The foregoing and other features of the present invention will be more readily apparent from the following detailed description and drawings of illustrative embodiments of the invention, where like reference numerals delineate similar elements throughout the several views. In the drawings:

FIG. 1 is a front view of a humidifier with a top opening and a bottom opening in accordance with the present invention;

FIGS. 2a-2b, taken along line 2-2 of FIG. 1, illustrate the operation of a valve actuator of the humidifier of FIG. 1;

FIG. 3 shows a cross-sectional view taken through sectional line 3-3 in FIG. 2a;

FIG. 4 shows a cross-sectional view taken through sectional line 4-4 in FIG. 2b;

FIG. 5 shows a cross-sectional view taken through line 5-5 in FIG. 4;

FIGS. 6a and 6b illustrate the operation of an alternative embodiment of the valve actuator of the present invention;

FIG. 7 shows a perspective view of a humidifier with an alternative actuator mechanism in accordance with the present invention; and

FIG. 8 shows a cross-sectional view of the actuator mechanism shown in FIG. 7.

### DETAILED DESCRIPTION OF THE PREFERRED EMBODIMENTS

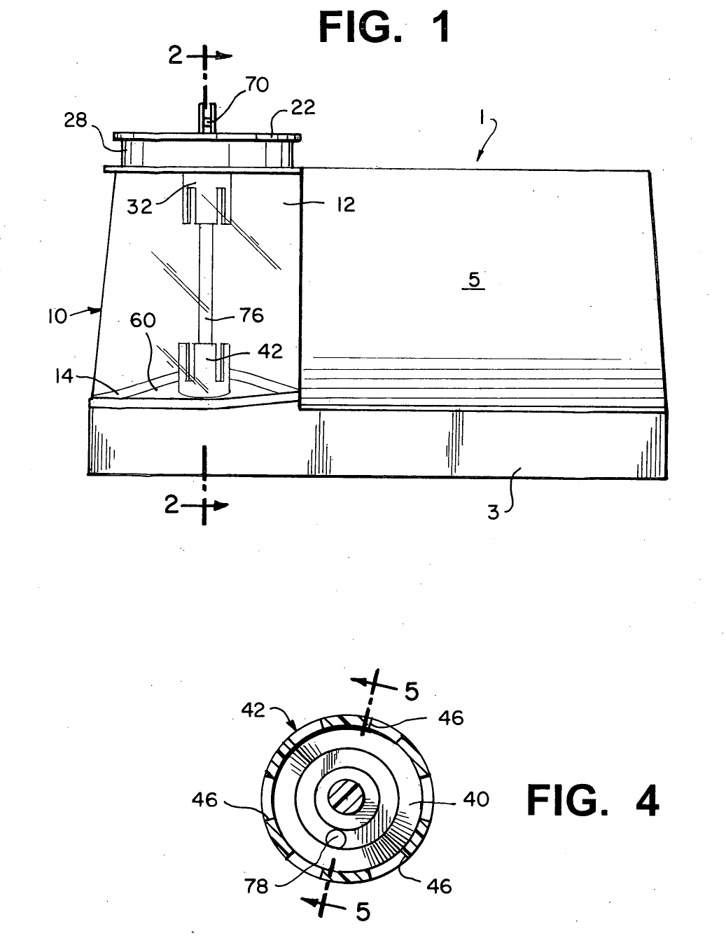

FIG. 1 shows a humidifier 1 with a water tank 10 that includes a top inlet opening 20 and a bottom inlet opening 60. Humidifier 1 includes a tray 3 which is supplied with water from the tank. The water in the tray 3 is dispersed into the surrounding environment by a humidifying mechanism 5, which is adjacent the water tank 10 and above the tray 3. The humidifying mechanism 5 is not limited to a specific type and may be any mechanism which can produce humidified air or vapor, such as a wick type humidifier, vaporizer or ultrasonic humidifier.

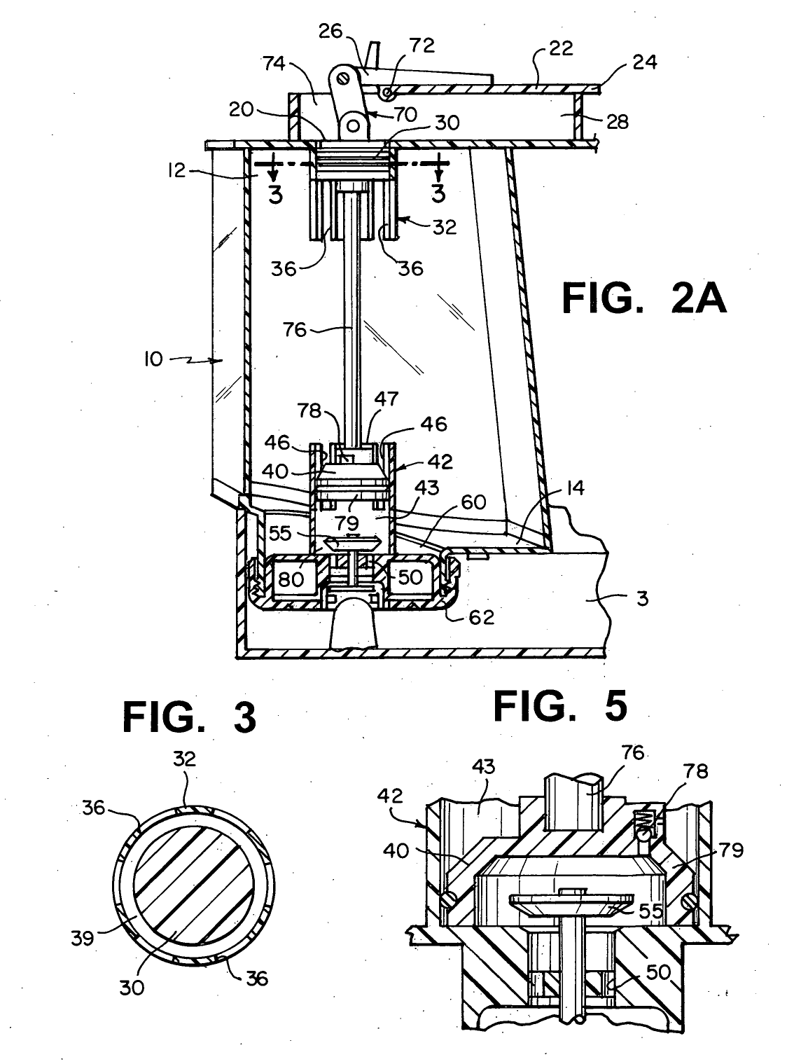

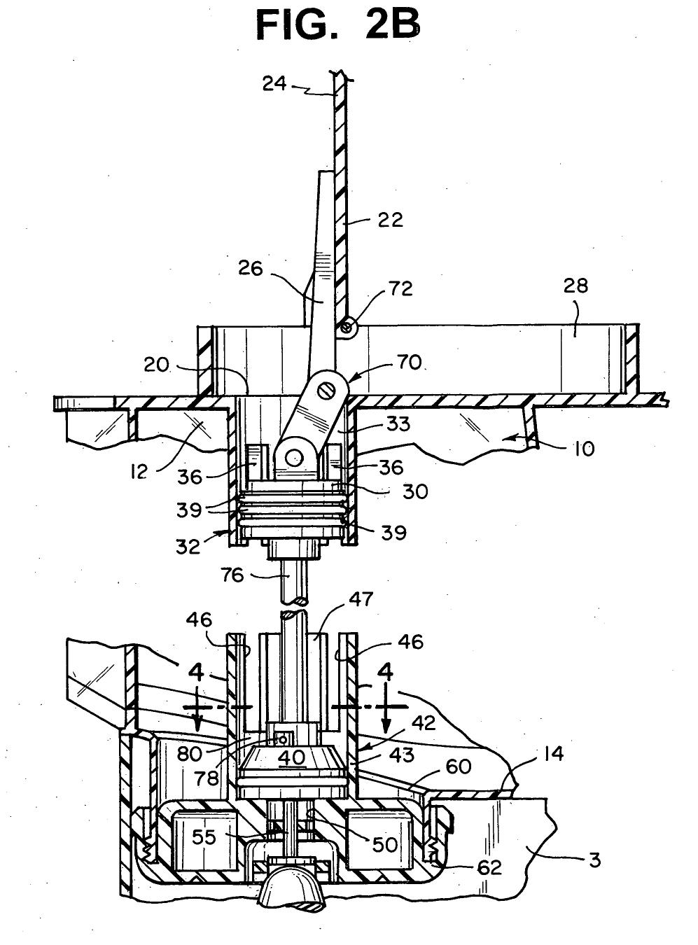

During operation, the water level in the tray 3 falls as water is dispersed into the surrounding environment by the humidifying mechanism 5. The water in the tray 3 is periodically automatically refilled from water in the tank 10. The water in the tank flows through an outlet 50 in the bottom of the tank 10. The outlet 50 is positioned just below the height of the maximum water level of the tray 3. As the water flows, the pressure in the tank decreases and a partial vacuum develops at the top 12 of the tank 10. The tank 10 is sealed, and the partial vacuum develops as water leaves the tank 10. The partial vacuum assures that only enough water pours out of the tank 10 to fill the tray 3. If the partial vacuum is preventing water from exiting the tank 10, but the tray 3 is not yet full, air will get sucked into the tank. The air restores pressure in the tank 10 and allows the water to flow again. However, once the tray 3 is full and the water in the tray is covering the outlet 50 (shown in FIGS. 2a and 5), there is no path for air to be drawn into the tank. Thus, the water cannot escape and the water level in the tray 3 remains at its maximum level.

After the humidifier 1 is used for an extended period of time, the water in the tank 10 becomes exhausted and the tank 10 needs to be refilled in order for the humidifier 1 to continue to operate. If water tank 10 is nearly or completely empty, it may be removed from the humidifier 1 and taken to a water source. A press valve 55 (shown in FIGS. 2a and 5) at the outlet 50 prevents any residual water from flowing out of tank 10. The press valve 55 may be spring loaded and designed such that the outlet 50 is only open when the press valve 55 is actuated. Placing the tank 10 on the tray 3, automatically opens the press valve 55. However, when the tank 10 is removed, the press valve 55 is closed. At the water source, the tank 10 can be filled through the top inlet opening 20, or the larger bottom inlet opening 60. Using the larger bottom inlet opening 60 allows the tank 10 to be filled more quickly. Each opening has a corresponding lid 22, 62, respectively, thereon (62 shown in FIGS. 2a and 2b). The top lid 22 is hinged and is opened and closed by lifting or lowering the lid. The bottom lid 62 is a threaded lid and is screwed on and off.

The tank 10 may also be filled from the top inlet 20 while it is in place on the humidifier 1 and the press valve 55 is open. Lifting the top lid 22 simultaneously opens the top opening 20 and closes the bottom opening 60. Closing the bottom opening 60 prevents water from continuously flowing out of the tank 10 once the partial vacuum in the tank 10 is relieved.

When the top lid 22 is closed, as shown in FIG. 2a, a top sealing member in the form of top valve 30 is positioned within a closed end 33 of inlet pipe 32. O-rings 39 provide the seal between top valve 30 and inlet pipe 32. At the bottom 14 of water tank 10 a bottom sealing member in the form of bottom valve 40 is positioned within an open end 47 of outlet pipe 42. Holes or slots 46 provide an opening for water to pass into outlet pipe 42. The water may also pass from outlet pipe 42 through outlet 50 because outlet valve 55 is in an open position. The water flows into tray 3 in a controlled manner as a result of the partial vacuum in tank 10 that is provided by the seal formed by top valve 30.

When the user wants to fill the tank 10 from the top end 12 he or she lifts the lid 22. By lifting the lid 22, as shown in FIG. 2b, an actuator 70 pushes the top valve 30 into an open end 37 of inlet pipe 32, breaking the seal and relieving the partial vacuum. Holes or slots 36 provide an opening for water to pass into tank 10. Simultaneously, the actuator 70 pushes the bottom valve 40 into a closed end 43 of the outlet pipe 42. This allows water to flow through the top inlet 20 but not out of the outlet 50.

As shown in FIGS. 2a-2b, as the lid 22 is lifted from its long end 24, it pivots about pin 72 such that short end 26 descends. A rocker arm 74, pinned at one end to short end 26, also descends as a result of the lifting of lid 22. The rocker arm 74 is pinned at its other end to top valve 30. Consequently, as the rocker arm 74 descends so does top valve 30 breaking the seal and relieving the partial vacuum. A connecting rod 76 links top valve 30 to bottom valve 40, such that the movement of top valve 30 and bottom valve 40 are synchronized. The top and bottom sealing members, or valves, are positioned such that upon lifting of lid 22 the bottom of the tank is sealed before the top seal is broken. Once the top lid 22 is completely opened, water may be poured into top reservoir 28 from which it passes through top inlet opening 20 into tank 10.

Bottom valve 40 may also include a check valve 78 on the body of the valve 79, as shown in FIG. 5. Check valve 78 permits water to flow up but prevents it from flowing down past bottom valve 40. Check valve 78 is useful for allowing water to exit the cavity 80 disposed between valve 55 and bottom valve 40 when valve 55 is closed. For instance, if tank 10 is removed from humidifier tray 3 valve 50 will close. When the user lifts lid 22, consequently lowering bottom valve 40, the water is allowed to escape cavity 80 rather than building in pressure.

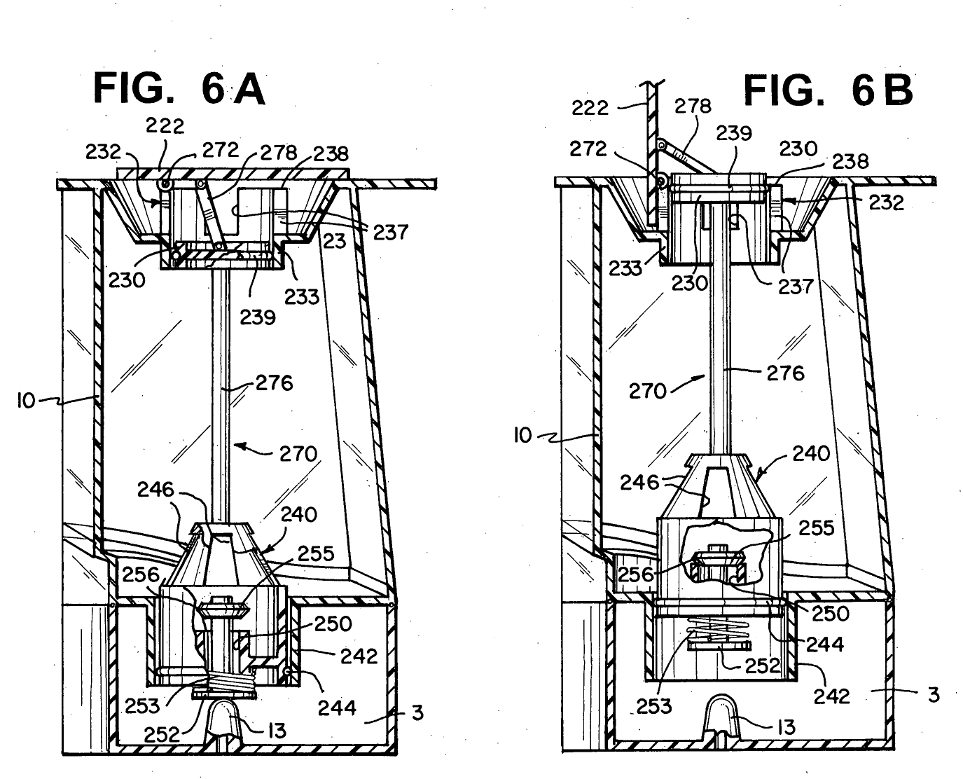

FIGS. 6a and 6b show another embodiment of a valve actuator 270 in accordance with the present invention. The valve actuator 270 includes a top valve 230 and a bottom valve 240 similar to what is shown in FIGS. 2a, 2b and 3-5. However, the opening mechanism and the seal at the bottom of the tank are somewhat different.

FIG. 6a shows the tank in an operating position. Lid 222 is closed such that rocker arm 274, which is pinned to lid 222, holds top valve 230 in a closed section 233 of inlet pipe 232. Top O-ring 239 surrounding top valve 230 creates a seal at the top end 12 of the tank 10. As a consequence air cannot flow out of tank 10. Connecting rod 276 is connected at one end to top valve 230. At the other end of connecting rod 276, bottom valve 240 is held in a lower position within outlet pipe 242. With bottom valve 240 in a lower position, projection 13 of tray 3 is held against plunger 252. Consequently, the other end of plunger 252, which contains seal 255 is held away from seal surface 256. Water, which passes through holes 246 into outlet pipe 242, is able to flow through opening 250 and into tray 3.

If tank 10 is removed from the tray 3, such that flange 13 is no longer holding plunger 252 up, a spring 253 returns plunger 252 to a position where seal 255 is held against seal surface 256. The combination of seal 255 and lower O-ring 244 guarantee that the lower end 14 of tank 10 is sealed. Thus, water is prevented from flowing out of the tank 10 as it is carried away from humidifier 1.

When a user chooses to refill tank 10, the lid 222 may be lifted about pin 272. As lid 222 is pivoted, rocker arm 278 pulls connecting rod 276 as well as top valve 230 and bottom valve 240 in an upward direction. As bottom valve 240 moves up within outlet pipe 242, seal surface 256 approaches seal 255 while spring 253 keeps plunger 252 down. Once bottom valve 240 is substantially raised, seal 255 contacts seal surface 256 preventing water from flowing out of tank 10. Meanwhile, at the top of the tank 12 top valve 230 and top O-ring 239 move toward open end 238 of inlet pipe 232. Once lid 222 is fully open, water is able to pass into tank 10 through slots 237 formed in the open end 238 of inlet pipe 232. Thus, the tank can be refilled.

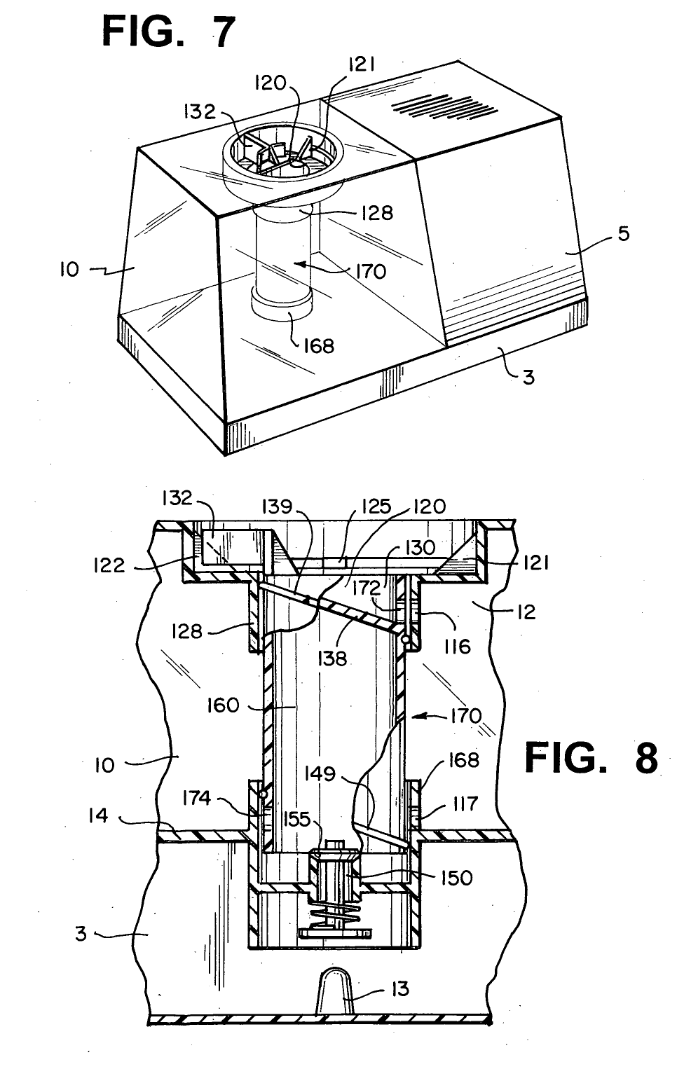

Another embodiment of humidifier 1 is shown in FIG. 7. Much of the humidifier of this embodiment operates in the same manner as previous embodiments. However, the actuator 170, as well as the fluid seals and passages are somewhat different. The actuator 170 shown in FIG. 7 is operated by twisting to open and close passages in the top 12 and bottom 14 of tank 10.

The cross-sectional view shown in FIG. 8 illustrates details of the actuator 170. Actuator 170 includes an upper chamber 130 and a lower chamber 160 separated by an angled wall 138 that is positioned within inlet pipe 128. A first alignment opening 172 is disposed in actuator 170 above the lowest part of wall 138. An upper O-ring 139 surrounds actuator 170 in a path that follows wall 138. Inlet pipe 128 also includes a first inlet opening 116 that is approximately level with first alignment opening 172. At the bottom of tank 10 outlet pipe 168 also has a second alignment opening 117 that is angularly aligned with first inlet opening 116. A second inlet opening 174 is disposed in the actuator and vertically aligned with second alignment opening 117. A lower O-ring 149 is wrapped around actuator 170 at an angle, such that it is above second inlet opening 174 on one side of the actuator 170 and below second inlet opening 174 on the other side. A press valve 155 and opening 150 are similar to those shown in the embodiment of FIGS. 2a and 5.

Actuator 170 is shown in a refill position in FIG. 8. The actuator is rotationally positioned such that openings 172 and 116 are aligned. Consequently, water poured into opening 120 may flow into tank 10 via openings 172 and 116. At the lower end 14 of tank 10, openings 117 and 174 are on opposite sides of actuator 170. Accordingly, second inlet opening 174 is separated from second alignment opening 117 by a seal formed by O-ring 149.

To place the actuator 170 in an operating position the user uses handle 132 to rotate actuator 170 half a turn (180°). Position limiters 121 and 122 set the end points of rotation and a position tab 125 holds the actuator 170 in place. Once the actuator is turned the wall 138 and O-ring 139 are re-aligned such that first inlet opening 116 is below the seal formed by O-ring 139, but first alignment opening 172 is still above it. Accordingly, the top of tank 10 is sealed. Similarly, at the bottom of the tank 10, the second inlet opening 174 is realigned to be adjacent opening 117, allowing water to pass through to opening 150 and into tray 3.

The angle and orientation of the O-rings as well as the orientation of the openings can vary provided that opening 116 is sealed from the environment when in the operating position and opening 174 is sealed from tank 10 when in the refill position.

Although the preferred forms of the invention have been shown and described, many features may be varied, as will readily be apparent to those skilled in this art. For example, separate actuators may be used to open and close the top and bottom openings. The outlet may be provided in the main body of the tank rather than in the bottom lid. It is the intention, therefore, to be limited only as indicated by the scope of the claims appended hereto.

We claim:

1. A humidifier comprising:
a tray for holding water;
a humidifying mechanism operable to receive water from the tray;
a water tank in fluid communication with the tray, comprising:
a first inlet opening in a top end,
a second inlet opening in a bottom end, the bottom end being positioned adjacent the tray,
an outlet in the bottom end operable to deliver water to the tray, and
an actuator mechanism coupled at a first end to the first inlet and coupled at a second end to the second inlet, the actuator mechanism operable to open said first inlet while closing said second inlet, and to close said first inlet while opening said second inlet.

2. A humidifier comprising:
a tray for holding water;
a humidifying mechanism operable to receive water from the tray;
a water tank in fluid communication with the tray, comprising:
a first inlet opening in a top end,
a second inlet opening in a bottom end, the bottom end being positioned adjacent the tray,
an outlet in the bottom end operable to deliver water to the tray, and
an actuator mechanism coupled at a first end to the first inlet and coupled at a second end to the second inlet, the actuator mechanism comprising a hinged arm at its first end, the hinged arm connected to and selectively positioning a first valve for selectively closing the first inlet, the hinged arm operable to selectively position a second valve at the second end of the actuator mechanism, such that the actuator mechanism is movable between a first position where the first inlet is opened and the second inlet is closed, to a second position where the first inlet is closed and the second inlet is open, the actuator mechanism operable to simultaneously position both the first and second valves.

3. The humidifier of claim 2 wherein the actuator mechanism includes a vertically movable connecting rod connected at a first end to the first valve and at a second end to the second valve.

4. The humidifier of claim 2 wherein the actuator mechanism further includes a rocker arm pinned at one end to the hinged arm and operable to couple the hinged arm to the first and second valves.

5. The humidifier of claim 2 wherein the hinged arm includes a hinged top lid operable to cover the first inlet.

6. The humidifier of claim 2 wherein the outlet includes a press valve.

7. The humidifier of claim 2 wherein the first valve is positioned within an inlet pipe and the second valve is positioned within an outlet pipe, each pipe having openings therein which allow water to pass through a respective pipe when the corresponding valve is in an open position.

8. The humidifier of claim 3 wherein the connecting rod is vertically elongated.

9. The humidifier of claim 2 wherein the hinged arm is a hinged top lid operable to cover the first inlet, and wherein the actuator mechanism further comprises:
a vertically movable connecting rod attached to the first valve at one end and the second valve at the other end, and
a rocker arm pinned to the first valve at one end and pinned to an end of the hinged top lid at another end,
wherein the hinged top lid is operable to move the rocker arm which moves the connecting rod and valves.

10. A humidifier comprising:
a tray for holding water;
a humidifying mechanism operable to receive water from the tray;
a water tank in fluid communication with the tray, comprising:
a first inlet opening in a top end,
a second inlet opening in a bottom end, the bottom end being positioned adjacent the tray,
an outlet in the bottom end operable to deliver water to the tray,
an actuator mechanism coupled at a first end to the first inlet and coupled at a second end to the second inlet, the actuator mechanism comprising a rotatable actuator that is rotatable between a first position where the first inlet is opened and the second inlet is sealed from the tank, to a second position where the first inlet is sealed from a surrounding environment and the second inlet is open, the rotatable actuator operable to simultaneously position both the first and second valves.

11. The humidifier of claim 10 wherein the rotatable actuator is tubular.

12. The humidifier of claim 11 wherein the rotatable actuator is held in a body of the water tank and includes an upper chamber and a lower chamber.

13. The humidifier of claim 12 wherein a passage from the tank includes an opening in each of the rotatable actuator and body of the water tank, the passage having an open position when the openings are aligned and a closed position when the openings are misaligned.

14. The humidifier of claim 10 wherein the outlet includes a press valve.

15. The humidifier of claim 12 wherein a passage into the tank includes an opening in each of the rotatable actuator and body of the water tank, the passage having an open position when the openings are aligned and a closed position when the openings are misaligned.
